(19) United States
(12) Patent Application Publication
(10) Pub. No.: US 2021/0046711 A1
(43) Pub. Date: Feb. 18, 2021

(54) BUILD MATERIAL QUALITY LEVEL BASED ON TEMPERATURES

(71) Applicant: HEWLETT-PACKARD DEVELOPMENT COMPANY, L.P., Spring, TX (US)

(72) Inventors: Ismael Fernandez Aymerich, Sant Cugat del Valles (ES); Pol Fornos Martinez, Sant Cugat del Valles (ES); Alejandro Manuel De Pena Hempel, Sant Cugat del Valles (ES)

(21) Appl. No.: 17/051,150

(22) PCT Filed: Sep. 14, 2018
(86) PCT No.: PCT/US2018/051144

§ 371 Date: Oct. 27, 2020

(51) Int. Cl. B29C 64/393; B29C 64/194

(52) U.S. Cl. CPC B29C 64/393; B29C 64/165; B29C 64/194

(57) ABSTRACT

An example of an apparatus is disclosed. The example disclosed herein comprises a sensor and a controller. The sensor, coupled to the controller, is to measure a temperature from a three-dimensional printing build material layer. The controller is to control an energy source to apply energy to the build material layer. The controller is further to measure a temperature from the build material layer using the sensor. The controller is also to determine a build material quality level comprising at least one of a first quality level, a second quality level, and a third quality level based on the measured temperature.

### BACKGROUND

Additive manufacturing may comprise the operation of spreading additive manufacturing build material in a build material layer and printing or jetting an energy absorbing fusing agent over areas of successive layers of un-solidified build material to be fused, and applying a fusing energy to the build material layer to cause portions thereof on which fusing agent was printed to heat up, melt, coalesce, sinter, or fuse.

In some examples, the not fused un-solidified build material may be recycled for subsequent print jobs. However, recycled build material may have properties or characteristics which are inferior to fresh build material. Consequently, objects generated with recycled build material may have inferior object properties compared to objects generated with fresh build material.

### BRIEF DESCRIPTION OF THE DRAWINGS

The present application may be more fully appreciated in connection with the following detailed description taken in conjunction with the accompanying drawings, in which like reference characters refer to like parts throughout and in which:

FIG. 1 is a block diagram illustrating an example of an apparatus to determine a build material quality level based on temperature.

FIG. 2 is a block diagram illustrating another example of an apparatus to determine a build material quality level based on temperature.

FIG. 3A is a block diagram illustrating another example of an apparatus to determine a build material quality level based on temperature.

FIG. 3B is a block diagram illustrating another example of an apparatus to determine a build material quality level based on temperature.

FIG. 4 is a block diagram illustrating another example of an apparatus to determine a build material quality level based on temperature.

FIG. 5A is a block diagram illustrating an example of a three-dimensional printer to determine a build material quality level based on temperature.

FIG. 5B is a block diagram illustrating an example of a build material management unit to determine a build material quality level based on temperature.

FIG. 6 is a flowchart of an example method for determining a build material quality level based on temperature.

FIG. 7 is a flowchart of another example method for determining a build material quality level based on temperature.

### DETAILED DESCRIPTION

The following description is directed to various examples of the disclosure. In the foregoing description, numerous details are set forth to provide an understanding of the examples disclosed herein. However, it will be understood by those skilled in the art that the examples may be practiced without all of these details. While a limited number of examples have been disclosed, those skilled in the art will appreciate numerous modifications and variations therefrom. It is intended that the appended claims cover such modifications and variations as fall within the scope of the examples. Throughout the present disclosure, the terms “a” and “an” are intended to denote at least one of a particular element. In addition, as used herein, the term “includes” means includes but not limited to, the term “including” means including but not limited to. The term “based on” means based at least in part on.

Additive manufacturing techniques, such as three-dimensional (3D) printing, may enable objects to be generated on a layer-by-layer basis. 3D printing techniques may generate layers of an object by forming successive layers of a build material on a build unit, and selectively solidifying portions of each layer of the build material. The layers of build material to be selectively solidified and/or after being solidified may be formed in a build unit. In an example, the build unit may be a removable build unit and may comprise a build material store to be filled with build material in a build material management unit. The build material management unit may be in a different physical location than the 3D printer. The removable build unit and build material store filled with build material may be installed in the 3D printer to allow the 3D printer to perform printing operations. In another example, the build unit may be a fixed build unit in a 3D printer, therefore the build material management unit being located within the boundaries of the 3D printer.

In the present disclosure, a build material management unit may be understood as a module in charge of performing the 3D printing operations other than selectively applying the agents on the build material layer, for example, filling the build material store of a build unit with build material, cooling down the contents of a build unit after 3D object generation, recycling any non-fused build material, and the like. A 3D printer should be understood as the system that at least performs the operation of applying printing agents on the build material layer. In some examples, the 3D printer comprises the build material management unit therein. In other examples, the build material management unit may be physically separate from the 3D printer and may use a mobile build unit movable between the build material management unit and the 3D printer. In some examples, the energy sources that emit energy to the build material layer to fuse the build material therein may be installed in the 3D printer. In other examples, the energy sources that emit energy to the build material layer to fuse the build material therein may be installed in the build material management unit. In yet other examples, the energy sources that emit energy to the build material layer to fuse the build material therein may be installed in the 3D printer and in the build material management unit, as described below.

The 3D printer may receive data representing a model of an object to be generated from a layer of build material, or slices of the object model. The data to print a 3D object may be derived from a 3D object model or slices thereof. An example of a 3D object model may be generated using a Computer Aided Design (CAD) application which is a tool that may be used to create precision drawings or technical illustrations. Another example of a 3D model may be a

Computer Aided Manufacturing (CAM) application which is a tool that may be used to design products such as electronic circuit boards in computers and other devices. The 3D printing data may, for example, describe at which locations on a build material layer drops of different print agents should be printed. A 3D object model may be defined, for example, in vector type format, and 2D rasterized images may be generated representing slices of the object model. Each slice may then be processed to determine how printing agents should be printed to generate a layer of an object corresponding to the slice. The 3D printing data defines the 3D object to print by, for example, defining the plurality of slices of said object model to be generated. Each slice may determine a cross-sectional area and/or a cross-sectional shape of the 3D object to be produced by the 3D printer. The cross-sectional area and/or the cross-sectional shape, may be the areas to be fused. Therefore, a slice from the plurality of slices may define which sections of the build material layer may need to be fused to generate each layer of the 3D object.

As discussed above, some additive manufacturing systems use build material in, for example, a powdered or granular form. According to an example of the present disclosure, a suitable build material may be a powdered semi-crystalline thermoplastic material. A suitable material may be Nylon 12, which is available, for example, from Sigma-Aldrich Co. LLC. Another suitable material may be PA 2200 which is available from Electro Optical Systems EOS GmbH. According to another example, a suitable build material may be PA12 build material commercially known as V1R10A “HP PA12” available from HP Inc.

In other examples, other suitable build materials may be used. Such materials may include, for example, powdered metal materials, powdered plastics materials, powdered composite materials, powdered ceramic materials, powdered glass materials, powdered resin material, powdered polymeric materials, and the like. Different powders may have different characteristics, such as different average particle sizes, different minimum and maximum particle sizes, different coefficient of friction, different angle of repose, and the like. In some examples non-powdered build materials may be used such as gels, pastes, and slurries. Additionally, or alternatively from the above, in some examples build materials may be formed from, or may include, short fibres that may, for example, have been cut into short lengths from long strands or threads of material.

Additive manufacturing may comprise the operation of spreading three-dimensional printer build material (referred to as build material hereinafter for simplicity) in a build material layer and printing or jetting an energy absorbing fusing agent over areas of successive layers of un-solidified build material to be fused. Then, fusing energy may be applied to the build material layer to cause portions thereof on which fusing agent was printed to heat up, melt, coalesce, sinter, or fuse. Some examples may pre-heat the build material layer to a temperature close to but below the melting temperature of the build material before the fusing agent is applied.

In some examples, any non-fused, or non-solidified, build material may be recycled for subsequent layers and/or subsequent print jobs. However, recycled build material may have properties or characteristics which are inferior to fresh build material. Consequently, objects generated with recycled build material may have inferior object properties compared to objects generated with fresh build material. With some build materials, the quality of the build material may be visually appreciated by the color of the build material. In an example, the quality of the build material may be defined by three groups of build material status: (i) non-degraded build material, (ii) oxidized but acceptable build material, and (iii) oxidized but unacceptable build material. The (i) non-degraded build material should be understood as the build material that is not degraded, and therefore, the build material particles that exhibits its original properties and/or characteristics therein. In an example, the non-degraded build material color may be white or similar (e.g., fresh PA12 in ambient light). The (ii) oxidized build material should be understood as the build material that is slightly degraded, and therefore, the build material particles that may have lost some of their initial properties and/or characteristics. In an example, the oxidized build material color may be yellow or similar (e.g., oxidized PA12 in ambient light). The (iii) oxidized but unacceptable (referred hereinafter as “degraded build material” for simplicity) should be understood as the build material that has a high level of oxidation and has properties or characteristics that are deemed generally unacceptable for use in 3D printing. In an example, the oxidized build material color may be brown or similar (e.g., degraded PA12 in ambient light). In one example, the more energy a non-solidified build material has received (e.g., receiving pre-heating and fusing irradiation), the more degraded it may be.

In additive manufacturing systems, build material degradation may pose multiple challenges. In the example above, it has been disclosed that depending on the degree of degradation, build material may have properties (e.g., mechanical properties) which are not generally acceptable for use in 3D printing. For example, the change of color of a degraded build material may lead to a change in the energy absorption degree of said build material. For example, given the same amount of received energy, a non-degraded white build material may absorb a different amount of energy than the oxidized yellow build material. Similarly, an oxidized yellow build material may absorb a different amount of energy than the degraded build material. A build material particle may fuse in response to energy absorbed therein, therefore a relatively more degraded build material particle may fuse before a relatively lesser degraded build material particle.

In the present disclosure, the term “fuse” shall be understood as fuse and/or melt, and/or coalesce, and/or sinter. For simplicity, terms “fuse”, “fusing”, and “to fuse” may be used throughout the disclosure.

Additive manufacturing systems may create a build material layer using a mix of recycled build material and fresh build material. The recycled build material may contain build material particles with multiple degrees of degradation, and therefore, having differing degrees of energy absorption. Some examples of build material mixes may comprise about an 80% of recycled build material and about 20% of fresh build material. Other examples of build material mixes may comprise about a 60% of recycled build material and about a 40% of fresh build material.

As used herein, the term “about” and “substantially” are used to provide flexibility to a numerical range endpoint by providing that a given value may be, for example, an additional 20% more or an additional 20% less than the endpoints of the range. The degree of flexibility of this term can be dictated by the particular variable and would be within the knowledge of those skilled in the art to determine based on experience and the associated description herein.

Due to the variability of the degree of absorption of the recycled build material in the build material layer, it may be challenging to determine the fusing point of the build material. Various examples will now be described that provide a build material quality level determination based on the temperature of the build material from the build material layer.

One example of the present disclosure provides an apparatus that comprises a sensor and a controller. The sensor may be to measure a temperature from a three-dimensional printing build material layer. The controller may be to (i) control an energy source to apply energy to the build material layer. The controller may be further to (ii) measure a temperature from the build material layer using the sensor. The controller may be also to (iii) determine a build material quality level based on the measured temperature.

Another example of the present disclosure provides a method comprising a plurality of operations to be performed. The method comprises (i) applying energy to a build material layer. The method also comprises (ii) measuring a temperature from the build material layer. The method further comprises (iii) determining a build material quality level based on the measured temperature.

Another example of the present disclosure provides a three-dimensional printer comprising a sensor, an energy source, and a controller. The energy source and the sensor may be coupled to the controller. The energy source may be to measure a temperature from a build material layer. The energy source may be to apply energy to the build material layer. The controller may be to (i) control the energy source to apply energy to the build material layer. The controller may be further to (ii) measure a temperature from the build material layer using the sensor. The controller may be also to (iii) determine a build material quality based on the measured temperature.

In yet another example of the present disclosure provides a non-transitory machine readable medium storing instructions executable by a processor. The non-transitory machine-readable medium may comprise (i) instructions to apply energy to a build material layer. The non-transitory machine-readable medium may also comprise (ii) instructions to measure a temperature from the build material layer. The non-transitory machine-readable medium may further comprise (iii) instructions to determine a build material quality level based on the measured temperature.

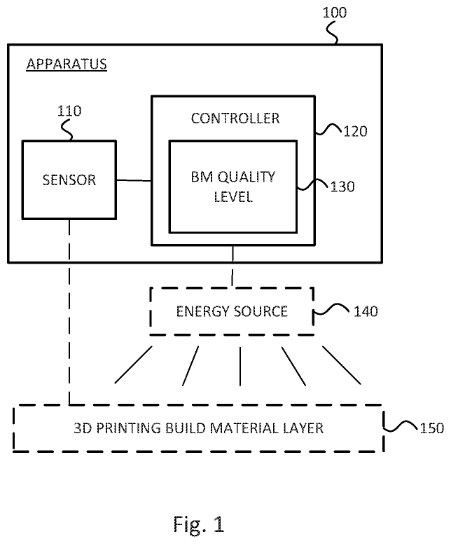

Referring now to the drawings, FIG. 1 is a block diagram illustrating an example of an apparatus 100 to determine build material quality level based on temperature. The apparatus 100 comprises a sensor 110 coupled to a controller 120.

The sensor 110 may be any suitable contactless temperature sensing device to measure the temperature of a build material layer 150. In an example, the sensor 110 may be a thermal camera, or any similar device that measures the temperature of a build material layer 150 area that the thermal camera spans. The thermal camera has an array of sensor elements at a defined resolution (e.g., 30 dpi), therefore the build material layer 150 temperature measurements may be made at this resolution. The higher the resolution of the thermal camera, the more precise the temperature measurement will be per surface unit (e.g., pixel, square inch, square centimeter). Lower resolution thermal cameras may tend to output the average temperature within each of the surface units. In another example, the sensor 110 may be a point thermal sensor, or any similar device that measures the temperature of a single point in the build material layer 150. Some examples of sensor 110 have been disclosed, however many other devices to measure the temperature of the build material layer 150 may be used without departing from the scope of the present disclosure.

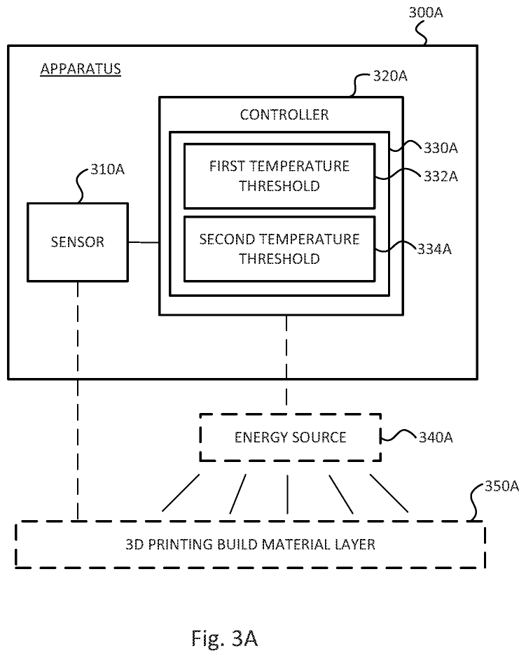

The build material layer 150 may be supplied to a build unit by an external device such as a layering module (e.g., layering module 380B from FIG. 3B). The build unit may be internal or removable from the apparatus 100 (e.g., the build unit with the build material layer 150 may not be present when the apparatus 100 is shipped). The build unit may comprise a build material store (not shown) including build material, and a build chamber (not shown) in which a build platform is moveable. In some examples, the moveable platform moves vertically. The build material comprised in the build material store may be a substantially homogenized mix of different build materials (e.g., recycled build material and fresh build material). The moveable build platform from the build unit may receive the mix of build material from the build material store in a form of build material layers 150 having a generally uniform thickness. Some examples may further comprise the build material layering mechanism (e.g., layering module 380B from FIG. 3B) to supply build material layers (e.g., build material layer 150) of uniform thickness to the build platform. The general uniform thickness may range from about 80 microns to about 120 microns, or be bigger or smaller. In an example, the vertical movement width of the moveable platform between two consecutive build material layers (e.g., how far the build platform is lowered) may determine the thickness of the latter layer. As disclosed above, the average energy absorptivity of the build material of the build material layer 150 may vary depending on the degradation state (e.g., fresh build material, oxidized build material, degraded build material) of the recycled build material in the build material layer 150.

The controller 120 may be further coupled to an energy source 140. The energy source 140 may be any device capable to irradiate energy to the build material layer 150 so that at least part of the irradiated energy gets absorbed by the build material particles of the build material layer 150. As an example, the energy source 140 may comprise a tungsten resistive element (e.g., heaters) that may, when powered, irradiate the build material layer 150 with a wide band of energy wavelengths. In other examples, the energy source 140 may be any device or array of devices capable to irradiate the build material layer 150 with a narrow band of energy wavelengths, or a single energy wavelength, for example, a Light-Emitting Diode (LED) array, and/or a laser beam. In some examples, the energy source 140 may be external to the apparatus 100. In other examples, the energy source 140 may be part of the apparatus 100.

The term “controller” as used herein may include a series of instructions encoded on a machine-readable storage medium and executable by a single processor or a plurality of processors. Additionally, or alternatively, a controller may include one or more hardware devices including electronic circuitry, for example a digital and/or analog application-specific integrated circuit (ASIC), for implementing the functionality described herein.

The controller 120 may control the energy source 140 to apply energy to the build material layer 150. In an example, the energy applied by the energy source 140 may be a preset amount of energy for testing the quality of the build material from the build material layer 150. In some examples, the preset amount of energy for testing the quality of the build material from the build material layer 150 may be independent from the pre-heating operation. In other examples, the preset amount of energy for testing the quality of the build material from the build material layer 150 may be included in the pre-heating operation. In an example, the intensity of the energy applied by the energy source 140 may be controlled by the controller 120. In another example, the time that the energy source 140 applies energy to the build material layer 150 may be controlled by the controller 120. In yet another example, the intensity of the energy applied by the energy source 140 and the time the energy source 140 applies energy to the build material layer 150 may be controlled by the controller 120. The preset amount of energy applied to the build material layer 150 may be absorbed, at least in part, by the particles of the build material layer 150. The amount of energy absorbed by the build material particles may be related to the average absorptivity of the build material particles. The energy absorbed by the particles of the build material layer 150 may lead to a build material particles temperature increase. In an example, the build material mix from the build material layer 150 comprises a substantially homogeneous quality of the build material particles therein (e.g., the average absorbance of the build material mix is substantially similar across the build material layer 150), therefore the temperature of all areas of the build material layer 150 may increase substantially evenly upon irradiation. In another example, the build material mix from the build material layer 150 comprises a heterogeneous quality of the build material particles therein (e.g., the average absorbance of the build material mix is substantially different across the build material layer 150), therefore the temperature of areas of the build material layer 150 may increase non-uniformly upon irradiation.

The controller 120 may measure a temperature from the build material layer using the sensor 110. In an example, the controller 120 may instruct a thermal camera to measure the temperatures of the surface units in an area of the build material layer 150. In another example, the controller 120 may instruct a point thermal sensor to measure the temperature of a location in the build material layer 150.

The controller 120 may determine a build material quality level 130 based on the measured temperature. As mentioned above, the temperature increase of build material particles may be related to the quality of the particles. The controller 120 may determine the quality or the degradation state of the build material from the build material layer 150 based on the measured temperature from the sensor 110. In an example, the controller 120 may determine the quality of the build material by matching the measured temperature in a look up table. In some examples, the look up table may map the temperature increase of the build material upon irradiation with the quality level of said build material. In other examples, the look up table may map the final temperature upon irradiation with the quality level of said build material. As mentioned above, the more degraded a build material mix is, the more energy it may absorb, on average. Consequently, the look up table may map the wider temperature increase and/or the higher final temperature with a higher degradation level. Otherwise, the look up table may map the narrower temperature increase and/or the lower final temperature with a lower degradation level. In another example, the controller 120 may determine the quality of the build material by comparing the measured temperature with a threshold temperature, as described below Some examples for determining the quality of the build material from the build material layer 150 based on the measured temperature have been disclosed, however other examples for determining the quality of build material particles based of the temperature may be derived therefrom without departing from the scope of the present disclosure.

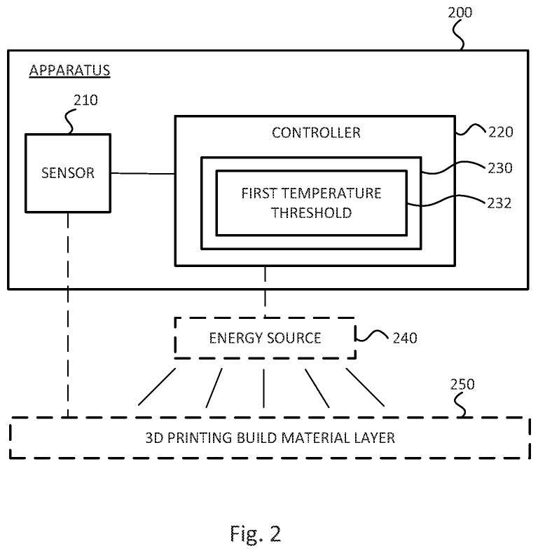

FIG. 2 is a block diagram illustrating another example of an apparatus 200 to determine build material quality level based on temperature. The apparatus 200 may comprise a sensor 210 coupled to a controller 220. The sensor 210 and the controller 220 may be the same as or similar to the sensor 110 and controller 120 from FIG. 1. The sensor 210 may be to measure a temperature from a build material layer 250. The build material layer 250 may be the same as or similar to the build material layer 150 from FIG. 1. The controller 220 may be coupled to an energy source 240 to apply energy to the build material layer 250. The energy source 240 may be the same as or similar to the energy source 140 from FIG. 1. In some examples, the energy source 240 and/or the build material layer 250 may be not be included in the apparatus 200. In other examples, the energy source 240 and/or the build material layer 250 may be included in the apparatus 200. The term “controller” as used herein may include a series of instructions encoded on a machine-readable storage medium and executable by a single processor or a plurality of processors. Additionally, or alternatively, a controller may include one or more hardware devices including electronic circuitry, for example a digital and/or analog application-specific integrated circuit (ASIC), for implementing the functionality described herein. The controller 220 may be to perform at least the same operations as controller 120 from FIG. 1, for example: (i) to control the energy source 240 to apply energy to the build material layer 250; (ii) to measure a temperature from the build material layer 250 using a sensor 210; and (iii) to determine a build material quality level 230 based on the measured temperature.

The controller 220 may be also programmed to perform further operations. For example, the controller 220 may be to determine the build material quality level 230 as a first quality level if the measured temperature is higher than a first temperature threshold 232. The first temperature threshold 232 may define the temperature that indicates the point that the build material particles from the build material layer 150 start to degrade (i.e., oxidized and start to not be acceptable for 3D printing). The first temperature threshold 232 may indicate whether a build material is degraded or not degraded. The first quality level may be understood as the quality level indicating that the particles of the build material from the build material layer 150 are degraded (e.g., low build material quality). Therefore, the controller 220 may determine that the build material layer 250 contains, at least in part, degraded build material if the measured temperature is a higher temperature than the first temperature threshold 232.

In an example, the first temperature threshold 232 may be selected based on the type of build material from the build material layer 250. Different build materials may have different acceptable degradation points, and therefore the first temperature threshold may vary depending on the type build material contained in the build material layer 250. In another example, the first temperature threshold 232 may also vary depending on a print mode intended to be used in the three-dimensional printing operation. In the present disclosure, a “print mode” should be understood as the definition of the printer and/or processing parameters that enable a printer to generate an object of a desired quality level or with a relative speed; for example, a “draft mode” may generate objects faster than a “normal mode”, but objects generated using a “draft mode” may have lower quality (or object properties) compared to a “normal mode”. In yet another example, the first temperature threshold 232 may also be defined based on a print agent intended to be used in the three-dimensional printing operation.

As mentioned above, degraded build material result in 3D printed objects having lower properties (e.g., mechanic properties), and therefore not be suitable for use in generating high quality objects. However, it may be acceptable to generate some 3D objects using degraded build material if they do not, for example, require a high degree of high integrity. For example, an object that is printed predominantly for its aesthetic appear may be printed using oxidized but acceptable build material (e.g., slightly degraded build material), therefore allowing a less strict first temperature threshold 230 definition. In an example of the present disclosure, three parameters should be satisfied to proceed with a printing operation: (i) a desired quality level indicated in a print job may be input (e.g., manually specified by the user, predetermined by the controller 220); (ii) the controller 220 may determine whether the quality level may be attainable by printing using a given print mode; and (iii) the quality of the build material provided is acceptable to print the print job in the desired quality level.

The controller 220 may be further to perform a first predefined operation based on the determination that the build material from the build material layer 150 is a first quality level build material. In an example, the first predetermined operation may include removing the layer of build material 250. The layer of build material 250 may be removed by an automatic layer removing mechanism or by the user. Some examples of automatic layer removing mechanisms may include vacuuming the build material from the build material layer 250. Other examples of automatic layer removing mechanisms may include mechanical means, such as rollers, blades, brooms, and the like to transfer (e.g., push) the build material from the build material layer 250 out of the build unit (e.g., by transferring the build material to containers installed next to or attached to the build unit). In another example, the first predetermined operation may include supplying another layer of build material to the build unit, therefore supplying another build material layer 250 on top of the previous build material layer 250. In yet another example, the first predetermined operation may include aborting the current print job.

FIG. 3A is a block diagram illustrating another example of an apparatus 300A to determine build material quality level based on temperature. The apparatus 300A may comprise a sensor 310A coupled to a controller 320A. The sensor 310A and the controller 320A may be the same as or similar to the sensor 110 and controller 120 from FIG. 1. The sensor 310A may be to measure a temperature from a build material layer 350A. The build material layer 350A may be the same as or similar to the build material layer 150 from FIG. 1. The controller 320A may be coupled to an energy source 340A to apply energy to the build material layer 350A. The energy source 340A may be the same as or similar to the energy source 140 from FIG. 1. In some examples, the energy source 340A and/or the build material layer 350A may be not included in the apparatus 300A. In other examples, the energy source 340A and/or the build material layer 350A may be included in the apparatus 300A. The term “controller” as used herein may include a series of instructions encoded on a machine-readable storage medium and executable by a single processor or a plurality of processors. Additionally, or alternatively, a controller may include one or more hardware devices including electronic circuitry, for example a digital and/or analog application-specific integrated circuit (ASIC), for implementing the functionality described herein. The controller 320A may be to perform at least the same operations as controller 120 from FIG. 1, for example: (i) to control the energy source 340A to apply energy to the build material layer 350A; (ii) to measure a temperature from the build material layer 350A using a sensor 310A; and (iii) to determine a build material quality level 330A based on the measured temperature.

The controller 320A may be also be programmed to perform further operations. For example, the controller 320A may be to determine the build material quality level 330A as a second quality level if the measured temperature is between a first temperature threshold 332A and a second lower temperature threshold 334A. The first temperature threshold 332A may be the same as or similar to the first temperature threshold 232 from FIG. 2.

As described above, the first temperature threshold 332A may define the temperature that indicates the point at which the build material particles from the build material layer 350A start to degrade (e.g., when they start no longer being acceptable for 3D printing). The first temperature threshold 332A may indicate whether a build material is degraded or not degraded. The second temperature threshold 334A may define the temperature that indicates the point at which that the build material particles from the build material layer 350A start to oxidize (e.g., the point at which fresh build material starts to oxidize). The second temperature threshold 334A may indicate whether a build material is oxidized or not. The first temperature threshold 332A may comprise a higher temperature than the second temperature threshold 334A, since the degraded build material (e.g., brown colored build material) may absorb more energy than the oxidized build material (e.g., yellow colored build material). The second quality level may be understood as the quality level indicating that the average of particles mix of the build material from the build material layer 350A are oxidized but acceptable (e.g., intermediate build material quality). Therefore, the controller 320A may determine that the build material layer 350A contains, at least in part, oxidized build material if the measured temperature is between a first temperature threshold 332A and a second lower temperature threshold 334A.

The first temperature threshold 332A and/or the second temperature threshold 334A may be selected based on the type of build material from the build material layer 350A. Different build materials may have different acceptable degradation and oxidation points, and therefore the first temperature threshold 332A and/or the second temperature threshold 334A may vary depending on the build material type contained in the build material layer 350A. In another example, the first temperature threshold 332A and/or the second temperature threshold 334A may also vary depending on a print mode intended to be used in the three-dimensional printing operation. In yet another example, the first temperature threshold 332A and/or the second temperature threshold 334A may also be defined based on a print agent intended to be used in the three-dimensional printing operation.

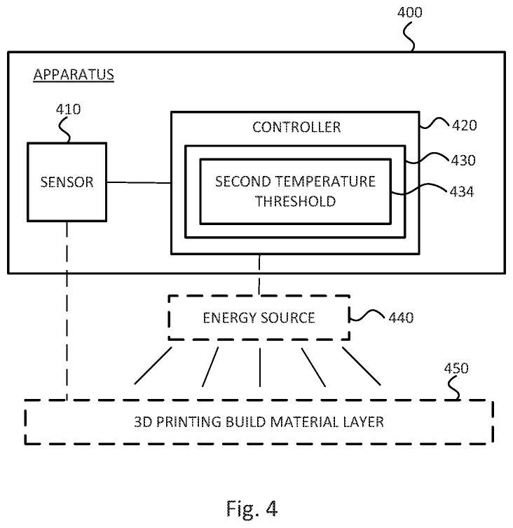

In an example of the present disclosure, upon determining that the build material from the build material layer 350A comprises, on average, a second quality build material, the controller 320A may further instruct a three-dimensional printer (see, e.g., three-dimensional printer 590A of FIG. 5A) or a build material management unit (see, e.g., build material management unit 590B from FIG. 5B) to modify a printing parameter. The printing parameters may be set by default into a fresh build material configuration (e.g., white colored build material), however the second quality build material (e.g., yellow colored build material) may absorb a larger amount of energy irradiated from the energy source 340A. Therefore, in the example herein, the controller may instruct to modify a printing parameter comprising the energy irradiation, and therefore the energy absorption, of the build material in the build material layer 350A. An example of printing parameter may comprise the energy source 340A intensity. Another example of printing parameter may comprise the time that the energy source 340A applies energy to the build material layer 350A. Yet another example of printing parameters may comprise the energy source 340A intensity and the time that the energy source 340A applies energy to the build material layer 350A. Some examples of printing parameters have been disclosed, however other examples may be derived therefrom without departing from the scope of the present disclosure.

Another example of an apparatus which may have determined that the build material from the build material layer comprises a second quality build material is disclosed in FIG. 3B.

FIG. 3B is a block diagram illustrating another example of an apparatus 300B to determine build material quality level based on temperature. The apparatus 300B may comprise a sensor 310B coupled to a controller 320B. The sensor 310B and the controller 320B may be the same as or similar to the sensor 110 and controller 120 from FIG. 1. The sensor 310B may be to measure a temperature from a build material layer 350B. The build material layer 350B may be the same as or similar to the build material layer 150 from FIG. 1. The controller 320B may be coupled to an energy source 340B to apply energy to the build material layer 350B. The energy source 340B may be the same as or similar to the energy source 140 from FIG. 1. In some examples, the energy source 340B and/or the build material layer 350B may be not included in the apparatus 200. In other examples, the energy source 340B and/or the build material layer 350B may be included in the apparatus 300B. The term “controller” as used herein may include a series of instructions encoded on a machine-readable storage medium and executable by a single processor or a plurality of processors. Additionally, or alternatively, a controller may include one or more hardware devices including electronic circuitry, for example a digital and/or analog application-specific integrated circuit (ASIC), for implementing the functionality described herein. The controller 320B may be to perform at least the same operations as controller 120 from FIG. 1, for example: (i) to control the energy source 340B to apply energy to the build material layer 350B; (ii) to measure a temperature from the build material layer 350A using a sensor 310B; and (iii) to determine a build material quality level 330B based on the measured temperature.

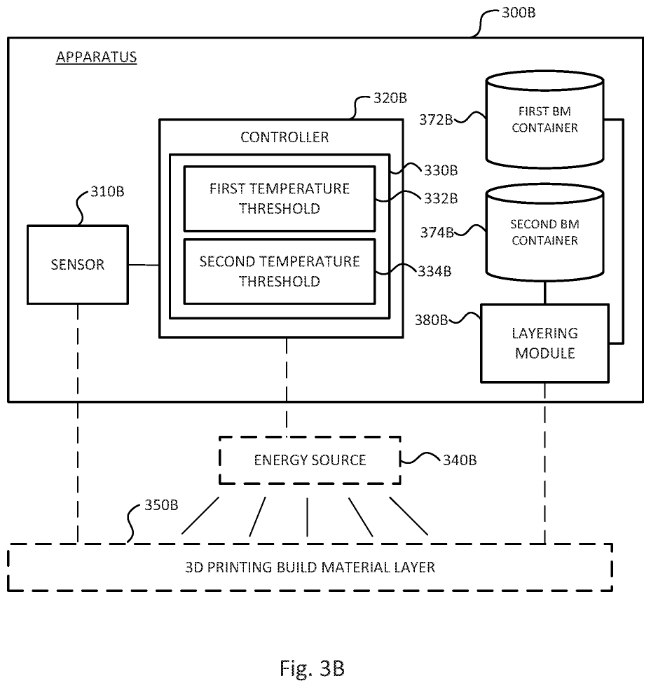

The apparatus 300B may further comprise first build material container 372B to contain fresh build material and a second build material container 374B to contain recycled build material. The fresh build material may be understood as non-degraded build material, therefore being a third quality level build material (see, e.g., FIG. 4). The recycled build material should be understood as the build material mix recovered from previous layers and/or print jobs that was not fused. Depending on the number of recycle cycles the recycled build material mix particles may have experienced, the degree of degradation may differ. In an example, a particle of build material from the recycled build material in the second build material container 374B may be a first quality build material particle, therefore being a degraded build material particle (e.g., brown-colored particle). In another example, a particle of build material from the recycled build material in the second build material container 374B may be a second quality build material particle, therefore being an oxidized build material particle (e.g., yellow-colored particle). In yet another example, a particle of build material from the recycled build material in the second build material container 374B may be a third quality build material particle, therefore being a fresh build material particle (e.g., white-colored particle). In some other examples, the second build material container 374B may contain a mix of build material particles from any combination of first, second, and/or third quality build materials.

The apparatus 300B may further comprise a layering module 380B to form build material layers (e.g., build material layer 350B) from a predetermined mix of build material from the first build material container 372B and the second build material container 374B. The layering module 380B may be any mechanism to form build material layers of a predetermined thickness (e.g., from about 80 microns to about 120 microns). The build material mix to create the build material layer 350B therefrom may include build material from the first build material container 372B, the second build material container 374B, or a combination thereof. In some examples, the layering module 380B may also comprise a mechanism to supply the build material from the first build material container 372B, and the second build material container 374B to the layering module 380B.

The controller 320B may be also programmed to perform further operations. For example, the controller 320B may be to determine the build material quality level 330B as a second quality level if the measured temperature is between a first temperature threshold 332B and a second lower temperature threshold 334B (e.g., second quality build material). The first temperature threshold 332B and the second temperature threshold 334B may be the same as or similar to the first temperature threshold 332A and the second temperature threshold 334A from FIG. 3A.

The first temperature threshold 332B and/or the second temperature threshold 334B may be selected based on the type of build material from the build material layer 350B. Different types of build material may have different acceptable degradation and oxidation points, and therefore the first temperature threshold 332B and/or the second temperature threshold 334B may vary depending on the type of build material contained in the build material layer 350B. In another example, the first temperature threshold 332B and/or the second temperature threshold 334B may also vary depending on the print mode intended to be used in the three-dimensional printing operation. In yet another example, the first temperature threshold 332B and/or the second temperature threshold 334B may also be defined based on a print agent intended to be used in the three-dimensional printing operation.

The controller 320B may be further to instruct a build material mixing module to modify the predetermined mix of build material by increasing the ratio of fresh to recycled build material. The build material mixing module may be any mechanism; or instructions encoded in a computer readable medium executed by a processor or a plurality of processors, to mix build material from the first build material container 372B and the second build material container 374B in a predetermined ratio determined by the controller 320B. In an example, the original predetermined recycling ratio may be about 80% recycled build material and about 20% fresh build material. Then, upon determining that the build material quality level from the build material in the build material layer 350B is a second quality level, the controller 320B may change the predetermined recycling ratio to about 75% recycled build material and about 15% fresh build material. In another example, the controller 320B may determine the additional quantity of fresh build material to be added to the mix of build material based on the temperature of the build material layer 350B. If, after energy has been applied, the average temperature of the build material layer 350B is similar but lower than the first temperature threshold 332B, the controller 320B may instruct the build material mixing module to add a big quantity of fresh build material from the first build material container 372B. However, if after the energy has been applied the average temperature of the build material layer 350B is similar but higher than the second temperature threshold 334B, the controller 320B may instruct the build material mixing module to add a small quantity of fresh build material from the first build material container 372B.

The controller 320B may be further to control the layering module 380B to form a subsequent layer of build material 350B with the modified predetermined mix of build material.

FIG. 4 is a block diagram illustrating another example of an apparatus 400 to determine build material quality level based on temperature. The apparatus 400 may comprise a sensor 410 coupled to a controller 420. The sensor 410 and the controller 420 may be the same as or similar to the sensor 110 and controller 120 from FIG. 1. The sensor 410 may be to measure a temperature from a build material layer 450. The build material layer 450 may be the same as or similar to the build material layer 150 from FIG. 1. The controller 420 may be coupled to an energy source 440 to apply energy to the build material layer 450. The energy source 440 may be the same as or similar to the energy source 140 from FIG. 1. In some examples, the energy source 440 and/or the build material layer 450 may be not included in the apparatus 400. In other examples, the energy source 440 and/or the build material layer 450 may be included in the apparatus 400. The elements from the apparatus 400 may be also the same as or similar to the elements of apparatus 200 of FIG. 2, apparatus 300A from FIG. 3A, and/or apparatus 300B from FIG. 3B. The term “controller” as used herein may include a series of instructions encoded on a machine-readable storage medium and executable by a single processor or a plurality of processors. Additionally, or alternatively, a controller may include one or more hardware devices including electronic circuitry, for example a digital and/or analog application-specific integrated circuit (ASIC), for implementing the functionality described herein. The controller 420 may be to perform at least the same operations as controller 120 from FIG. 1, for example: (i) to control the energy source 440 to apply energy to the build material layer 450; (ii) to measure a temperature from the build material layer 450 using a sensor 410; and (iii) to determine a build material quality level 430 based on the measured temperature.

The controller 420 may be also programmed to perform further operations. For example, the controller 420 may be to determine the build material quality level 430 as a third quality level if the measured temperature is lower than a second temperature threshold 434.

The second temperature threshold 434 may define the temperature that indicates the point that the build material particles from the build material layer 450 start to oxidize. The second temperature threshold 434 may indicate whether a build material is non-degraded (e.g., fresh build material) or oxidized but acceptable. The third quality level may be understood as the quality level indicating that the particles of the build material from the build material layer 450 are either non-degraded or oxidized/degraded. Therefore, the controller 420 may determine that the build material layer 450 contains, at least in part, non-degraded build material if the measured temperature is lower than the second threshold. Upon determining that the build material from the build material layer 450 is a third quality build material, the controller may proceed with the print job with the build material from the build material layer 450.

The second temperature threshold 434 may be the same as or similar to the second temperature threshold 334A and/or 334B from FIG. 3A and 3B. In an example, the second temperature threshold 434 may be selected based on the type of build material from the build material layer 450. Different types of build materials may have different oxidation points, and therefore the second temperature threshold may vary depending on the type of build material contained in the build material layer 450. In another example, the second temperature threshold 434 may also vary depending on the print mode intended to be used in the three-dimensional printing operation. In yet another example, the second temperature threshold 434 may also be defined based on a print agent intended to be used in the three-dimensional printing operation.

FIG. 5A is a block diagram illustrating an example of a three-dimensional printer 590A to determine build material quality level based on temperature. The three-dimensional printer 590A may comprise an apparatus 500A therein. The apparatus 500A may comprise a controller 520A coupled to a sensor 510A and an energy source 540A. The sensor 510A may be to measure a temperature from a build material layer. The energy source 540A may be to apply energy to the build material layer. The controller may comprise a build material quality level 530A. The term “controller” as used herein may include a series of instructions encoded on a machine-readable storage medium and executable by a single processor or a plurality of processors. Additionally, or alternatively, a controller may include one or more hardware devices including electronic circuitry, for example a digital and/or analog application-specific integrated circuit (ASIC), for implementing the functionality described herein. The controller 520A may be to perform at least the same operations as controller 120 from FIG. 1, for example: (i) to control the energy source 540A to apply energy to the build material layer; (ii) to measure a temperature from the build material layer using a sensor 510A; and (iii) to determine a build material quality level 530A based on the measured temperature.

In an example, the apparatus 500A as well as the sensor 510A, the controller 520A, the build material quality level 530A, and the energy source 540A, may be the same as or similar to the apparatus 100, the sensor 110, the controller 120, the build material quality level 130, and the energy source 140 from FIG. 1. In another example, the apparatus 500A as well as the sensor 510A, the controller 520A, the build material quality level 530A, and the energy source 540A, may be the same as or similar to the apparatus 200, the sensor 210, the controller 220, the build material quality level 230, and the energy source 240 from FIG. 2. In another example, the apparatus 500A as well as the sensor 510A, the controller 520A, the build material quality level 530A, and the energy source 540A, may be the same as or similar to the apparatus 300A, the sensor 310A, the controller 320A, the build material quality level 330A, and the energy source 340A from FIG. 3A. In another example, the apparatus 500A as well as the sensor 510A, the controller 520A, the build material quality level 530A, and the energy source 540A, may be the same as or similar to the apparatus 300B, the sensor 310B, the controller 320B, the build material quality level 330B, and the energy source 340B from FIG. 3B. In yet another example, the apparatus 500A as well as the sensor 510A, the controller 520A, the build material quality level 530A, and the energy source 540A, may be the same as or similar to the apparatus 400, the sensor 410, the controller 420, the build material quality level 430, and the energy source 440 from FIG. 4.

FIG. 5B is a block diagram illustrating an example of a build material management unit 590B to determine build material quality level based on temperature. The build material management unit 590B may comprise an apparatus 500B therein. The apparatus 500B may comprise a controller 520B coupled to a sensor 510B and an energy source 540B. The sensor 510B may be to measure a temperature from a build material layer. The energy source 540B may be to apply energy to the build material layer. The controller may comprise a build material quality level 530B. The term “controller” as used herein may include a series of instructions encoded on a machine-readable storage medium and executable by a single processor or a plurality of processors. Additionally, or alternatively, a controller may include one or more hardware devices including electronic circuitry, for example a digital and/or analog application-specific integrated circuit (ASIC), for implementing the functionality described herein. The controller 520B may be to perform at least the same operations as controller 120 from FIG. 1, for example: (i) to control the energy source 540B to apply energy to the build material layer; (ii) to measure a temperature from the build material layer using a sensor 510B; and (iii) to determine a build material quality level 530B based on the measured temperature.

In an example, the apparatus 500B as well as the sensor 510B, the controller 520B, the build material quality level 530B, and the energy source 540B, may be the same as or similar to the apparatus 100, the sensor 110, the controller 120, the build material quality level 130, and the energy source 140 from FIG. 1. In another example, the apparatus 500B as well as the sensor 510B, the controller 520B, the build material quality level 530B, and the energy source 540B, may be the same as or similar to the apparatus 200, the sensor 210, the controller 220, the build material quality level 230, and the energy source 240 from FIG. 2. In another example, the apparatus 500B as well as the sensor 510B, the controller 520B, the build material quality level 530B, and the energy source 540B, may be the same as or similar to the apparatus 300A, the sensor 310A, the controller 320A, the build material quality level 330A, and the energy source 340A from FIG. 3A. In another example, the apparatus 500B as well as the sensor 510B, the controller 520B, the build material quality level 530B, and the energy source 540B, may be the same as or similar to the apparatus 300B, the sensor 310B, the controller 320B, the build material quality level 330B, and the energy source 340B from FIG. 3B. In yet another example, the apparatus 500B as well as the sensor 510B, the controller 520B, the build material quality level 530B, and the energy source 540B, may be the same as or similar to the apparatus 400, the sensor 410, the controller 420, the build material quality level 430, and the energy source 440 from FIG. 4.

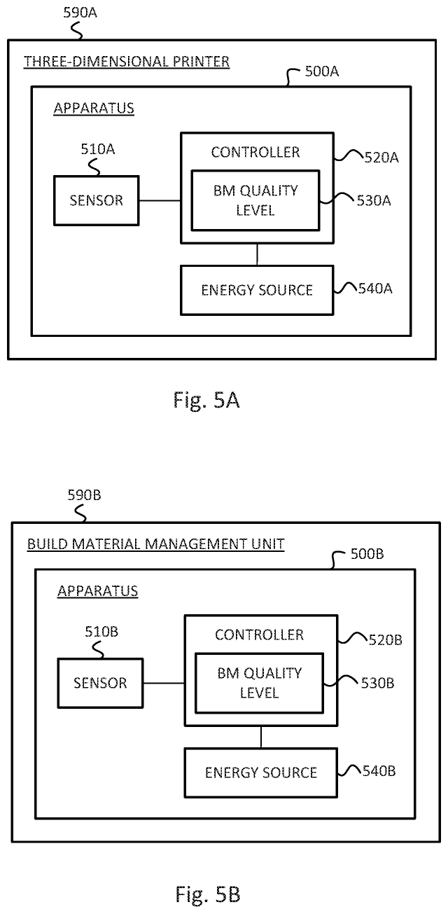

FIG. 6 is a flowchart of an example method 600 for determining build material quality level based on temperature. Method 600 may be described below as being executed or performed by an apparatus, such as apparatus 100 of FIG. 1. Various other suitable apparatuses and/or systems may be used as well, such as, for example apparatus 200 of FIG. 2, apparatus 300A of FIG. 3A, apparatus 300B from FIG. 3B, apparatus 400 from FIG. 4, three-dimensional printer 590A from FIG. 5A, and build material management unit 590B from FIG. 5B. Method 600 may be implemented in the form of executable instructions stored on a machine-readable storage medium and executed by a single processor or a plurality of processors of the apparatus 100, and/or in the form of any electronic circuitry, for example digital and/or analog ASIC. In some implementations of the present disclosure, method 600 may include more or less blocks than are shown in FIG. 6. In some implementations, one or more of the blocks of method 600 may, at certain times, be performed in parallel and/or may repeat.

Method 600 may start at block 610, and continue to block 620, where an energy source (e.g., energy source 140 from FIG. 1) may apply energy to a build material layer (e.g., build material layer 150 from FIG. 1). At block 630, a sensor (e.g., sensor 110 from FIG. 1) may measure a temperature from the build material layer. At block 640, a controller (e.g., controller 120 from FIG. 1) may determine a build material quality level (e.g., build material quality level 130 from FIG. 1) based on the measured temperature. At block 650, method 600 may end. Method 600 may be repeated multiple times to build the 3D object, each time being printed a subsequent layer.

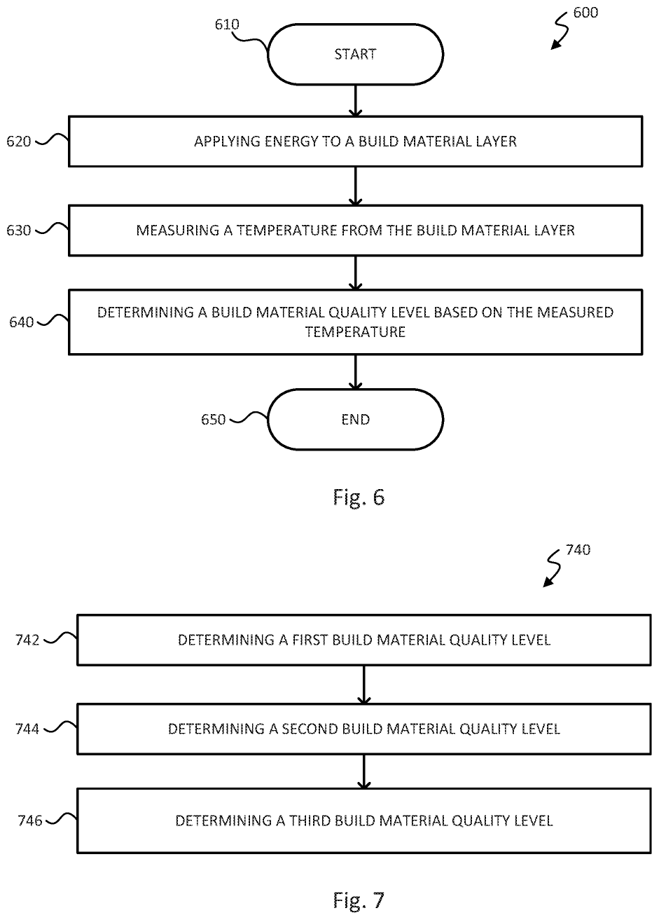

FIG. 7 is a flowchart of another example method 740 for determining build material quality level based on temperature. Method 740 may be an implementation of block 640 from method 600 from FIG. 6; however, block 640 may have other possible implementations without departing from the scope of the present disclosure. Method 740 may be described below as being executed or performed by an apparatus, such as apparatus 100 of FIG. 1. Various other suitable apparatuses and/or systems may be used as well, such as, for example apparatus 200 of FIG. 2, apparatus 300A of FIG. 3A, apparatus 300B from FIG. 3B, apparatus 400 from FIG. 4, three-dimensional printer 590A from FIG. 5A, and build material management unit 590B from FIG. 5B. Method 740 may be implemented in the form of executable instructions stored on a machine-readable storage medium and executed by a single processor or a plurality of processors of the apparatus 100, and/or in the form of any electronic circuitry, for example digital and/or analog ASIC. In some implementations of the present disclosure, method 740 may include more or less blocks than are shown in FIG. 7. In some implementations, one or more of the blocks of method 740 may, at certain times, be performed in parallel and/or may repeat.

At block 742, a controller (e.g., controller 120 from FIG. 1) may determine a first build material quality level if the measured temperature is higher than the first temperature threshold. At block 744, the controller may determine a second build material quality level if the measured temperature is between the first temperature threshold and the second temperature threshold. At block 746, the controller may determine a third build material quality level if the measured temperature threshold is lower than the second temperature threshold. Method 700 may be repeated multiple times to build the 3D object, each time being printed a subsequent layer.

The above examples may be implemented by hardware, or software in combination with hardware. For example, the various methods, processes and functional modules described herein may be implemented by a physical processor (the term processor is to be implemented broadly to include CPU, processing module, ASIC, logic module, or programmable gate array, etc.). The processes, methods and functional modules may all be performed by a single processor or split between several processors; reference in this disclosure or the claims to a “processor” should thus be interpreted to mean “at least one processor”. The processes, method and functional modules are implemented as machine-readable instructions executable by at least one processor, hardware logic circuitry of the at least one processors, or a combination thereof.

Throughout the present disclosure, multiple references have been made to a first quality level with regards to non-degraded white build material, a second quality level with regards to oxidized yellow build material, and a third quality level with regards to degraded brown build material. However, the color of the build material in the different degraded states may differ from the above depending on the type, conditions, and characteristics of the build material chosen. It shall be understood that said color differences are further comprised within the scope of the present disclosure without the prejudice of the wording above, since the color code above shall be understood as an example of many possible implementations of the claims.

The drawings in the examples of the present disclosure are some examples. It should be noted that some units and functions of the procedure may be combined into one unit or further divided into multiple sub-units. What has been described and illustrated herein is an example of the disclosure along with some of its variations. The terms, descriptions and figures used herein are set forth by way of illustration. Many variations are possible within the scope of the disclosure, which is intended to be defined by the following claims and their equivalents.

Example implementations can be realized according to the following clauses:

Clause 1: An apparatus comprising: a sensor to measure a temperature from a three-dimensional printing build material layer; and the controller to (i) control an energy source to apply energy to the build material layer, (ii) measure a temperature from the build material layer using the sensor, and (iii) determine a build material quality level based on the measured temperature.

Clause 2: The apparatus of clause 1, wherein the controller is to (i) determine the build material quality level as a first quality level if the measured temperature is higher than a first temperature threshold, and only where it is so determined, (ii) instruct a layer removing mechanism to perform a first predefined operation that includes one or more of removing a layer of build material, and aborting a print job.

Clause 3: The apparatus of any preceding clause, wherein the controller is to determine the build material quality level as a second quality level if the measured temperature is between a first temperature threshold and a second lower temperature threshold.

Clause 4: The apparatus of any preceding clause, further comprising (i) a first build material container to contain fresh build material; (ii) a second build material container to contain recycled build material; (iii) a layering module to form the build material layer from a predetermined mix of build material from the first build material container and the second build material container; and (iv) the controller, when it has determined the build material quality level as second quality level, is further to instruct a build material mixing module to modify the predetermined mix of build material by increasing the ratio of fresh to recycled build material, and control the layering module to form a subsequent layer of build material with the modified predetermined mix of build material.

Clause 5: The apparatus of any preceding clause, wherein the apparatus is part of a three-dimensional printer or a build material management system.

Clause 6: The apparatus of any preceding clause, wherein upon determining that the build material quality level has a second quality level, the controller is to instruct a three-dimensional printer to modify a printing parameter.

Clause 7: The apparatus of any preceding clause, wherein the printing parameter is at least one of an energy source intensity, and/or a time that the energy source applies energy to the build material layer.

Clause 8: The apparatus of any preceding clause, wherein the controller is to determine the build material quality level as a third quality level if the measured temperature is lower than a second threshold.

Clause 9: The apparatus of any preceding clause, wherein the first temperature threshold and the second temperature threshold are selected based on at least one of (i) a type of build material from the build material layer; (ii) a print mode intended to be used in a three-dimensional printing operation; and/or (iii) a print agent intended to be used in the three-dimensional printing operation.

Clause 10: The apparatus of any preceding clause, wherein the apparatus is part of a three-dimensional printer comprising at least one of the controller, the sensor, and the energy source.

Clause 11: The apparatus of any preceding clause, wherein the apparatus is part of a build material management unit comprising at least one of the controller, the sensor, and the energy source.

Clause 12: The apparatus of any preceding clause, wherein the sensor is one of a thermal camera or a point thermal sensor.

Clause 13: A method comprising (i) applying energy to a build material layer; (ii) measuring a temperature from the build material layer; and (iii) determining a build material quality level based on the measured temperature.

Clause 14: The method of clause 13, wherein determining the build material quality level is further based on a first temperature threshold and a second lower temperature threshold, the method further comprising (i) determining a first build material quality level if the measured temperature is higher than the first temperature threshold; (ii) determining a second build material quality level if the measured temperature is between the first temperature threshold and the second temperature threshold; and (iii) determining a third build material quality level if the measured temperature is lower than the second temperature threshold.

Clause 15: The method of any of the clauses 13 to 14, further comprising (i) determining the build material quality level as a first quality level if the measured temperature is higher than a first temperature threshold, and (ii) performing a first predefined operation that includes one or more of removing a layer of build material, and aborting a print job.

Clause 16: The method of any of the clauses 13 to 15, when it has determined the build material quality level as second quality level, the method further comprising (i) instructing a build material mixing module to modify the predetermined mix of build material by increasing the ratio of fresh to recycled build material, and (ii) controlling the layering module to form a subsequent layer of build material with the modified predetermined mix of build material.

Clause 17: The method of any of the clauses 13 to 16, being executed at least in part by a three-dimensional printer or a build material management system.

Clause 18: The method of any of the clauses 13 to 17, further instructing a three-dimensional printer to modify a printing parameter.

Clause 19: The method of any of the clauses 13 to 18, wherein the printing parameter is at least one of an energy source intensity, and/or a time that the energy source applies energy to the build material layer.

Clause 20: The method of any of the clauses 13 to 19, further selecting the first temperature threshold and the second temperature threshold based on at least one of (i) a type of build material from the build material layer; (ii) a print mode intended to be used in a three-dimensional printing operation; and/or (iii) a print agent intended to be used in the three-dimensional printing operation.

Clause 21: The method of any of the clauses 13 to 20, wherein the sensor is one of a thermal camera or a point thermal sensor.

Clause 22: A non-transitory machine-readable medium storing instructions executable by a processor, the non-transitory machine-readable medium comprising (i) instructions to apply energy to a build material layer; (ii) instructions to measure a temperature from the build material layer; and (iii) instructions to determine a build material quality level based on the measured temperature.

Clause 23: The non-transitory machine-readable medium of clause 22, wherein the instructions to determine the build material quality level are further based on a first temperature threshold and a second lower temperature threshold, the machine-readable medium further comprising (i) instructions to determine a first build material quality level if the measured temperature is higher than the first temperature threshold; (ii) instructions to determine a second build material quality level if the measured temperature is between the first temperature threshold and the second temperature threshold; and (iii) instructions to determine a third build material quality level if the measured temperature is lower than the second temperature threshold.

Clause 24: The non-transitory machine-readable medium of any of the clauses 22 to 23, further comprising (i) instructions to determine the build material quality level as a first quality level if the measured temperature is higher than a first temperature threshold, and (ii) instructions to perform a first predefined operation that includes one or more of removing a layer of build material, and aborting a print job.

Clause 25: The non-transitory machine-readable medium of any of the clauses 22 to 24, when it has been determined that the build material quality level as second quality level, the machine-readable medium further comprises (i) instructions to instruct a build material mixing module to modify the predetermined mix of build material by increasing the ratio of fresh to recycled build material, and (ii) instructions to control the layering module to form a subsequent layer of build material with the modified predetermined mix of build material.

Clause 26: The non-transitory machine-readable medium of any of the clauses 22 to 25, being executed at least in part by a three-dimensional printer or a build material management system.

Clause 27: The non-transitory machine-readable medium of any of the clauses 22 to 26, further comprising instructions to instruct a three-dimensional printer to modify a printing parameter.

Clause 28: The non-transitory machine-readable medium of any of the clauses 22 to 27, further comprising instructions to select the printing parameter from at least one of an energy source intensity, and/or a time that the energy source applies energy to the build material layer.

Clause 29: The non-transitory machine-readable medium of any of the clauses 22 to 28, further comprising instructions to select the first temperature threshold and the second temperature threshold based on at least one of (i) a type of build material from the build material layer; (ii) a print mode intended to be used in a three-dimensional printing operation; and/or (iii) a print agent intended to be used in the three-dimensional printing operation.

Clause 30: The non-transitory machine-readable medium of any of the clauses 22 to 29, wherein the sensor is one of a thermal camera or a point thermal sensor.

Clause 31: A three-dimensional printer comprising (i) a sensor, coupled to a controller, to measure a temperature from a build material layer; (ii) an energy source, coupled to the controller, to apply energy to the build material layer; and (iii) the controller to control the energy source to apply energy to the build material layer, control the energy source to apply energy to the build material layer, and determine a build material quality level based on the measured temperature.

Clause 32: The three-dimensional printer of clause 31, wherein the controller is to (i) determine the build material quality level as a first quality level if the measured temperature is higher than a first temperature threshold, and (ii) perform a first predefined operation that includes one or more of removing a layer of build material and aborting a print job.

Clause 33: The three-dimensional printer of any of the clauses 31 to 32, wherein the controller is to determine the build material quality level as a second quality level if the measured temperature is between a first temperature threshold and a second lower temperature threshold.

Clause 34: The three-dimensional printer of any of the clauses 31 to 33, further comprising (i) a first build material container to contain fresh build material; (ii) a second build material container to contain recycled build material; (iii) a layering module to form the build material layer from a predetermined mix of build material from the first build material container and the second build material container; and (iv) the controller, when it has determined the build material quality level as second quality level, is further to instruct a build material mixing module to modify the predetermined mix of build material by increasing the ratio of fresh to recycled build material, and control the layering module to form a subsequent layer of build material with the modified predetermined mix of build material.

Clause 35: The three-dimensional printer of any of the clauses 31 to 34, wherein the controller is to instruct a three-dimensional printer to modify a printing parameter.

Clause 36: The three-dimensional printer of any of the clauses 31 to 35, wherein the printing parameter is at least one of an energy source intensity, and/or a time that the energy source applies energy to the build material layer.

Clause 37: The three-dimensional printer of any of the clauses 31 to 36, wherein the controller is to determine the build material quality level as a third quality level if the measured temperature is lower than a second threshold.

Clause 38: The three-dimensional printer of any of the clauses 31 to 37, wherein the first temperature threshold and the second temperature threshold are selected based on at least one of (i) a type of build material from the build material layer; (ii) a print mode intended to be used in a three-dimensional printing operation; and/or (iii) a print agent intended to be used in the three-dimensional printing operation.

Clause 39: The three-dimensional printer of any of the clauses 31 to 38, wherein the sensor is one of a thermal camera or a point thermal sensor.

What it is claimed is:

1. An apparatus comprising:
a sensor to measure a temperature from a three-dimensional printing build material layer; and
a controller to:
control an energy source to apply energy to the build material layer, measure a temperature from the build material layer using the sensor, and
determine a build material quality level based on the measured temperature.

2. The apparatus of claim 1, wherein the controller is to:
determine the build material quality level as a first quality level if the measured temperature is higher than a first temperature threshold; and only where it is so determined, instruct a layer removing mechanism to perform a first predefined operation that includes one or more of removing a layer of build material, and aborting a print job.

3. The apparatus of claim 1, wherein the controller is to:
determine the build material quality level as a second quality level if the measured temperature is between a first temperature threshold and a second lower temperature threshold.

4. The apparatus of claim 3, further comprising:
a first build material container to contain fresh build material and a second build material container to contain recycled build material,
a layering module to form the build material layer from a predetermined mix of build material from the first build material container and the second build material container, and wherein
the controller, when it has determined the build material quality level as second quality level, is further to:
instruct a build material mixing module to modify the predetermined mix of build material by increasing the ratio of fresh to recycled build material, and
control the layering module to form a subsequent layer of build material with the modified predetermined mix of build material.

5. The apparatus of claim 4, wherein the apparatus is part of a three-dimensional printer or a build material management system.

6. The apparatus of claim 3, upon determining that the build material quality level has a second quality level, the controller is to instruct a three-dimensional printer to modify a printing parameter.

7. The apparatus of claim 6, wherein the printing parameter is at least one of an energy source intensity, and/or a time that the energy source applies energy to the build material layer.

8. The apparatus of claim 1, wherein the controller is to:
determine the build material quality level has a third quality level if the measured temperature is lower than a second threshold.

9. The apparatus of claim 3, wherein the first temperature threshold and the second temperature threshold are selected based on at least one of:
a type of build material from the build material layer;
a print mode intended to be used in a three-dimensional printing operation; and/or
a print agent intended to be used in the three-dimensional printing operation.

10. The apparatus of claim 1, wherein the apparatus is part of a three-dimensional printer comprising at least one of the controller, the sensor, and the energy source.

11. The apparatus of claim 1, wherein the apparatus is part of a build material management unit comprising at least one of the controller, the sensor, and the energy source.

12. The apparatus of claim 1, wherein the sensor is one of a thermal camera or a point thermal sensor.

13. A method comprising:
applying energy to a build material layer;
measuring a temperature from the build material layer; and
determining a build material quality level based on the measured temperature.

14. The method of claim 13, wherein determining the build material quality level is further based on a first temperature threshold and a second lower temperature threshold, the method further comprising:
determining a first build material quality level if the measured temperature is higher than the first temperature threshold;
determining a second build material quality level if the measured temperature is between the first temperature threshold and the second temperature threshold; and
determining a third build material quality level if the measured temperature is lower than the second temperature threshold.

15. A three-dimensional printer comprising:
a sensor, coupled to a controller, to measure a temperature from a build material layer;
an energy source, coupled to the controller, to apply energy to the build material layer; and
the controller to:
control the energy source to apply energy to the build material layer,
control the energy source to apply energy to the build material layer, and
determine a build material quality level based on the measured temperature.
